(19) United States
(12) Patent Application Publication
(10) Pub. No.: US 2002/0056947 A1
(43) Pub. Date: May 16, 2002

(54) Method for marking bowling pins

(76) Inventor: Arnold Jager, Burgdorf (DE)

Correspondence Address: ROBERT W. BECKER & ASSOCIATES, 707 HIGHWAY 66 EAST, SUITE B, TIJERAS, NM, 87059, US

(21) Appl. No.: 09/985,955

(22) Filed: Oct. 10, 2001

Related U.S. Application Data
(63) Continuation-in-part of application No. 09/338,016, filed on Jun. 22, 1999, now abandoned.

(30) Foreign Application Priority Data
Jun. 22, 1998 (DE) 198 27 652.4

(51) Int. Cl. B29C 49/02; B29C 49/22

(52) U.S. Cl. 264/454; 264/482; 264/514; 264/132

(57) ABSTRACT

In a method for visually marking bowling pins, a plastic material is blow-molded to form a bowling pin mantle. At least one laser beam is impinged onto the bowling pin mantle and guided in a pattern to create a desired marking by either activating pigments under the mantle skin or making the base color of the bowling pin mantle lighter.

### CROSS-REFERENCES TO RELATED APPLICATIONS

This application claims the priority of German Patent Application Ser. No. 198 27 652.4 filed Jun. 22, 1998, and is a continuation-in-part application of U.S. Ser. No. 09/338,016 filed Jun. 22, 1999.

### BACKGROUND OF THE INVENTION

The present invention relates to a method for marking bowling pins by visually recongnizable signs and images, for example, numbers, lettering, trademarks, and symbols.

In the context of the present invention, bowling pins are meant to include all kinds of pins for any type of bowling game.

The invention relates to such bowling pins having an outer shell or mantle comprised of tenacious hard, impact-resistant plastic material, whereby this mantle encloses a porous or cell-structure plastic core but may also enclose a wood core.

It is conventional to embody the outer mantle or shell in a very light color, especially in white, in order to be thus able to easily detect the pins. Other color schemes are also possible, for example, red or green colors. Furthermore, the outer surface of the bowling pin is often provided with signs or images, and it is often required to provide at the exterior of the bowling pin a manufacturer identification.

According to know suggestions, these identifications and markings are printed onto the bowling pin. This method is beneficial with regard to so-called wooden bowling pins having a service life of more than 2,000 throws, but is ineffective in regard to the aforementioned plastic bowling pins because they have a service life of more than 4,000 throws and the imprinted identification or marking cannot withstand such load.

It is therefore an object of the present invention to provide a method for realizing a permanent marking or identification on the bowling pin mantle of plastic bowling pins.

### SUMMARY OF THE INVENTION

The solution to this object is inventively realized by a laser treatment whereby one or more laser beams are guided in a pattern to create the desired marking or identification. This method causes the color, resulting from the manufacture or the molding of the bowling pin, to be weakened such that the desired marking or identification becomes visible. Furthermore, it is also possible to mix pigments into the plastic material used for manufacturing the bowling pin, whereby these pigments within the molded bowling pin mantle are activated by the at least one laser beam guided across the surface so as to create the desired marking or identification.

In the case of mixing pigments into the plastic material, upon activation they will take on a black or dark gray color that is easily visible from the exterior and is very permanent. Such markings or identifications will survive the considerably longer service life of such plastic bowling pins, respectively, of plastic bowling pin mantles with which bowling pins are provided.

The inventive effect is based on the fact that the pigments or dyes that produce the desired marking or identification are no longer positioned at the exterior of the bowling pin mantle but are protected within the plastic material of the bowling pin mantle. Accordingly, frictional forces acting onto the exterior of the mantle and impacts acting on the exterior of the mantle will not have an effect on the pigments or color particles and cannot frictionally remove them. The color particles or pigments are not applied as a surface coating but are embedded in the plastic material of the exterior mantle or the bowling pin. It is also possible to adjust the depth of penetration, respectively, the activation depth of the laser beam electrically, for example, by increasing or decreasing the intensity of the laser beam.

It should be noted that the bowling pin mantle can also be comprised of two or more layers. In this case, only the outer layer or skin of the mantle must be provided with pigments.

Even when no pigments are used within the bowling pin mantle, a sufficient permanency of the marking or identification will result because the diminished color is not only present within the exterior skin of the bowling pin body but also in sufficient depth beneath the outer skin. This method is suitable in any situation where there is the desire to produce within a base color of the bowling pin as a marking or identification a lighter color (or a darker color, depending on the base color) of this base color, for example, for a green base color a lighter tone of green for the marking, while when using the aforementioned pigments and, for example, a white base color a dark grey or even black identification or marking will result. The pigments thus contribute to an improved color differentiation.

### BRIEF DESCRIPTION OF THE DRAWINGS

The object and advantages of the present invention will appear more clearly from the following specification in conjunction with the accompanying drawings, in which:

FIG. 1 shows a device for blow molding a bowling pin mantle;

FIG. 2 shows a vertical section of the bowling pin mantle already filled with the core material, whereby the auxiliary device for introduction of the core material is still attached;

FIG. 3 shows the finished plastic bowling pin with hardened mantle during treatment with a laser device; and

FIG. 4 shows the outer skin surface of the bowling pin mantle treated in accordance with FIG. 3.

### DESCRIPTION OF PREFERRED EMBODIMENTS

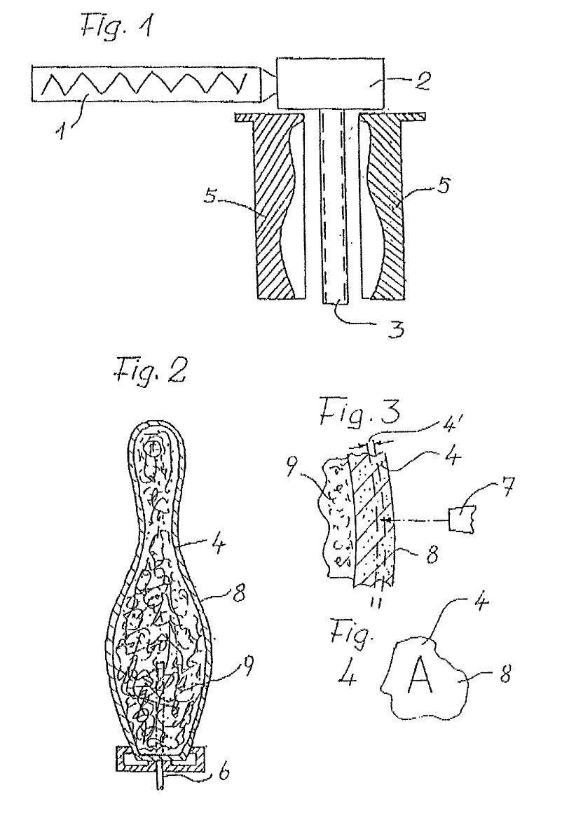

The present invention will now be described in detail with the aid of several specific embodiments utilizing FIGS. 1 through 4.

An extruder 1 having an extruder (blower) head 2 serves for producing a hose 3 for generating the mantle 4 for the bowling pin. A thermoplastic material is supplied to the extruder 1. For example, a plastic material such as polypropylene with added pigments is used which pigments are activatable by laser treatment, i.e., will be discolored or change their color such that a black or dark color will result. The plastic base material is of a light color or white.

The two mold halves 5 for molding the bowling pin mantle 4 are represented in the open state. For the molding step of the bowling pin they are brought into contact.

The mantle 4 of the bowling pin is produced from a plastic material hose 3 within the extruder or blower head 2. The two mold halves 5 are closed and the hose 3 is cut to length and then blown.

The blow-molding and extrusion-molding processes for forming the first and second mantle layers of the bowling pin can be performed simultaneously or consecutively. That is, the method can be performed such that, in a first step, the plastic material which forms the first bowling pin mantle layer can be blow-molded at the same time a plastic material used to form the second bowling pin mantle layer is extrusion-molded. In a second, subsequent step, at least one laser beam is impinged onto the first and second bowling pin mantle layers and the laser beam is guided in a pattern to create the desired markings, in the manner to be described below.

Alternatively, the inventive method can be performed such that, in a first step, the plastic material forming the first bowling pin mantle layer is blow-molded. In a subsequent, second step, the plastic material forming the second bowling pin mantle layer is extrusion-molded. Finally, in a third step, the laser beam is impinged onto the first and second mantle layers and guided to create the desired markings, in the manner to be described below.

After the mantle 4 has cooled and thus hardened so as to be stiff and stable, it is introduced into an injection machine having an injection needle 6 with which the material for the bowling pin core 9 is injected into the mantle 4. The material for the bowling pin core may be polyamide or polypropylene containing a blowing agent.

Subsequent to molding and introduction of the bowling pin core, lettering or markings are applied to the bowling pin. For this purpose, a laser device with a laser head 7 is provided whose laser beam penetrates into the mantle 4 and activates the pigments embedded therein so that they change to a dark gray or black color such that in view of the white mantle 4 the desired marking or identification, for example, the letter A, is visible.

It is important in this context that the laser beam, respectively, its intensity is selected such that it penetrates to approximately 0.3 mm to 1 mm into the mantle 4, whereby it is active only past a depth of 0.2 mm so that the aforementioned activation of the pigments will occur. This means that the lettering or marking is arranged below a protective skin of the mantle 4 and the mantle skin positioned above the marking acts as a protective film. The effective range of the laser treatment is thus below the surface 8 approximately in the area 4′ whereby, even though this area is positioned below the surface 8, it is easily visible because of the light or white coloring of the mantle 4.

When for a white base color no pigment is used, the laser treatment will result in a light grey marking. When, for example, red, green or yellow base colors are used for the bowling pin and no pigments are employed, a light red, light green or light yellow marking or identification will result. These markings or identifications without pigments are useful in those situations, respectively, satisfactory in a situation where the primary goal is to have some form of identification, irrespective of its type.

The specification incorporates by reference the disclosure of German priority document 198 27 652.4 of Jun. 22, 1998.

The present invention is, of course, in no way restricted to the specific disclosure of the specification and drawings, but also encompasses any modifications within the scope of the appended claims.

What is claimed is:

1. A method for visually marking bowling pins, said method comprising the steps of:
a) blow-molding a plastic material to form a first bowling pin mantle layer and simultaneously extrusion-molding a plastic material to form a second bowling pin mantle layer; and
b) impinging at least one laser beam onto at least one of said first and second bowling pin mantle layers and guiding the at least one laser beam in a pattern to create a desired marking.

2. The method according to claim 1, further including the step of mixing pigments into the plastic material before the step a), wherein in step b) the pigments are activated by the at least one laser beam such that the pigments take on a color different from the color of the bowling pin mantle not subjected to the at least one laser beam.

3. The method according to claim 2, wherein the plastic material with pigments mixed in is employed only in a surface layer of the bowling pin mantle.

4. A method for visually marking bowling pins, said method comprising the steps of:
a) blow-molding a plastic material to form a first bowling pin mantle layer;
b) extrusion-molding a plastic material to form a second bowling pin mantle layer; and
c) impinging at least one laser beam onto at least one of said first and second bowling pin mantle layers and guiding the at least one laser beam in a pattern to create a desired marking.

5. The method according to claim 4, further including the step of mixing pigments into the plastic material before the steps a) and b), wherein in step c) the pigments are activated by the at least one laser beam such that the pigments take on a color different from the color of the bowling pin mantle not subjected to the at least one laser beam.

6. The method according to claim 5, wherein the plastic material with pigments mixed in is employed only in a surface layer of the bowling pin mantle.
